(19) United States
(12) Patent Application Publication
(10) Pub. No.: US 2026/0269245 A1
(43) Pub. Date: Sep. 10, 2026

(54) Sodium Ion Battery, Method for Producing a Sodium Ion Battery and Use of a Sodium Ion Battery

(71) Applicant: Bayerische Motoren Werke Aktiengesellschaft, Muenchen (DE)

(72) Inventors: Roland JUNG, Schwangau (DE); Thomas WOEHRLE, Muenchen (DE)

(21) Appl. No.: 19/489,290

(22) PCT Filed: May 28, 2024
(86) PCT No.: PCT/DE2024/100489

§ 371 Date: Dec. 2, 2025

(30) Foreign Application Priority Data
Jun. 21, 2023 (DE) 10 2023 116 279.9

(51) Int. Cl. H01M 4/58; H01M 4/587; H01M 10/054

(52) U.S. Cl. CPC H01M 4/5825; H01M 4/587; H01M 10/054; H01M 2220/20

(57) ABSTRACT

A sodium ion battery is provided. The sodium ion battery includes a cathode which has a composite cathode active material, and an anode which has an anode active material. The composite cathode active material includes at least a first cathode active material and a second cathode active material. The first cathode active material and/or the second cathode active material is a polyanionic cathode active material. Prior to a first discharging and/or charging process of the sodium ion battery, the first cathode active material is fully sodiated and the second cathode active material is fully desodiated. The anode active material is pre-sodiated prior to the first discharging and/or charging process of the sodium ion battery. Also provided are a method for producing a sodium ion battery of this type and a use of a sodium ion battery of this type.

### BACKGROUND AND SUMMARY

The invention relates to a sodium ion battery, a process for producing a sodium ion battery and the use of a sodium ion battery.

The term “sodium ion battery” is used synonymously hereinafter for all names commonly used in the art for sodium-containing galvanic elements and cells, for example, sodium battery, sodium cell, sodium ion cell, sodium polymer cell, sodium ion polymer cell and sodium ion accumulator. In particular, rechargeable batteries (secondary batteries) are included. The terms “battery” and “electrochemical cell” are also used synonymously with the term “sodium ion battery”. The sodium ion battery may also be a solid-state battery, for example, an inorganic, ceramic, gel-based or polymer-based solid-state battery.

In order to meet the demand for electrochemical energy storage means for stationary and mobile applications, there is increasing focus on lithium-free galvanic elements or systems. Sodium ion batteries are an alternative fundamentally known in the art to the electrochemical storage means based on lithium-containing compounds.

A sodium ion battery has at least two different electrodes: a positive electrode (cathode) and a negative electrode (anode). Each of these electrodes has at least one active material which is referred to correspondingly as cathode active material or anode active material, electively together with additions such as electrode binders and electrical conductivity additives, for example, conductive carbon black.

There is a general description of sodium ion technology in Chen et al.: “Readiness Level of Sodium-Ion Battery Technology: A Materials Review” (Adv. Sustainable Syst. 2018, 2, 1700153, doi: 10.1002/adsu.201700153) and in Hasa et al.: “Challenges of today for Na-based batteries of the future: From materials to cell metrics” (Journal of Power Sources, 2021, 282, 22872, doi: 10.1016/j.jpowsour.2020.228872).

In sodium ion batteries, both the cathode active material and the anode active material have to be capable of reversibly accepting and releasing sodium ions.

Sodium ion batteries have a few benefits compared to other known systems. For instance, sodium ion batteries permit the use of hard carbon rather than graphite as anode active material. Hard carbon is producible at lower temperature than synthetic graphite and, by virtue of the greater mechanical stability of its particles, can be more intensively calendered or densified than synthetic or natural graphite. Moreover, it is possible to make use of a cathode active material that is not based on nickel and cobalt and is inexpensive. Moreover, sodium as active ion, i.e., as the ion which is reversibly accepted and released, is significantly cheaper than lithium and of virtually unlimited availability. Since sodium does not form alloys with aluminum, it is additionally possible in sodium ion batteries to use current collectors or carrier foils based on aluminum rather than copper in the anode, which can significantly reduce costs. Moreover, the materials used in sodium ion batteries, compared to the components used in lithium ion batteries, are generally more chemically stable and can in particular be processed in contact with air and with moisture, which allows simplification of the process regime in the production process, which in turn results in a reduction in costs.

Sodium ion batteries, in the current state of the art, are put together and assembled in the fully uncharged state. This corresponds to a state in which the sodium ions are fully intercalated in the cathode, while the anode typically does not have any active, i.e., reversibly cyclable, sodium ions.

In the first discharging operation of the sodium ion battery, also known by the term “formation”, the sodium ions leave the cathode and are intercalated in the anode. This first charging operation includes complex processes with a multitude of reactions that proceed between the different components of the sodium ion battery.

Of particular significance here is the formation of an interface between negative active material, i.e., the anode active material, and the electrolyte of the sodium ion battery at the anode. This interface is also referred to as solid electrolyte interphase or SEI. The formation of the SEI, which can also be regarded as a protective layer, is attributed essentially to break down reactions of the electrolyte with the surface of the anode active material and is sodium ion-conducting.

However, formation of the SEI requires sodium, which is no longer available later for cycling in the charging and discharging process. The difference between capacity after the first charge and capacity after the first discharge, in relation to the charging capacity, is referred to as formation loss and, depending on the cathode active material and anode active material used, may be in the range from about 5% to 40%.

The cathode active material therefore has to be oversized, i.e., provided in a greater amount, in order to achieve a desired nominal capacity of the finished sodium ion battery even after formation loss, which increases production costs and reduces the specific energy of the battery. This also increases the need for potentially toxic metals and compounds and/or those that are not of unlimited availability and are needed for the production of the cathode active material or arise in the processing of the cathode active material, for example, in recycling processes.

In the cell manufacture known in the prior art, the sodium ion batteries are first assembled in the uncharged state and then formed. Formation is an extremely costly process since both special equipment has to be provided for the purpose and the highest safety standards have to be observed, especially with regard to fire protection.

It is an object of the invention to provide a sodium ion battery that has high specific energy and lifetime, and an inexpensive process for producing such a sodium ion battery. A further object of the invention is that of implementing a simplified production process for the sodium ion battery in which, in particular, the precharge or forming process is dispensed with. The “precharge process” in this context refers to a first charge of the cell in order to form an SEI and to assure a stable cell voltage.

The object is achieved in accordance with the invention by a sodium ion battery with a cathode comprising a composite cathode active material, and an anode comprising an anode active material. The composite cathode active material comprises at least a first cathode active material and a second cathode active material, where the first cathode active material and/or the second cathode active material is a polyanionic cathode active material, and where the first discharging and/or charging operation on the sodium ion battery is preceded by full sodiation of the first cathode active material and full desodiation of the second cathode active material. The first discharging and/or charging operation of the sodium ion battery is preceded by presodiation of the anode active material.

According to the invention, a fully sodiated active material has a sodiation level of 1 and a fully desodiated active material a sodiation level of 0, while a sodiated or pre-sodiated active material has a sodiation level of greater than 0.

The term “sodiation level” refers to the content of reversibly cyclable sodium, in the form of sodium ions, metallic sodium and/or sodium alloys, per formula unit of the active material in relation to the maximum content of reversibly cyclable sodium of the active material. In other words, the sodiation level is a measure of how many percent of the cyclable sodium defined by the formula unit of the active material is intercalated within the structure of the active material.

It will be apparent that the amount of reversibly cyclable sodium depends on the voltage range in which the sodium ion battery is to be operated. Accordingly, the formula unit of the active material may include sodium which is not reversibly cyclable in the respectively intended voltage range, even if it would be reversibly cyclable if the voltage range were extended to comparatively higher voltages. In that case, the sodiation level refers merely to the proportion of sodium which is reversibly cyclable within the voltage range chosen.

In particular, the voltage range is limited by a maximum voltage of not more than 5.0 V, preferably of not more than 4.5 V, more preferably of not more than 4.3 V.

For example, in a stoichiometric sodium vanadium phosphate fluoride (NVPF) with the formula unit Na₃V₂ (PO₄)F₃, the sodiation level is 1, and in the corresponding desodiated compound NaV₂ (PO₄)F₃, the sodiation level is 0, when the voltage range has a maximum voltage of not more than 4.3 V, especially when the voltage range has a voltage in the range from 2.0 V to 4.3 V.

It is also possible to report the sodiation level in percent by multiplying the respective sodiation level value by 100%. For example, a sodiation level of 1 also corresponds to a sodiation level of 100%, a sodiation level of 0.5 to a sodiation level of 50%, and a sodiation level of 0 to a sodiation level of 0%.

Formation loss occurs virtually exclusively during the first discharging and/or charging operation. In particular, the original state of the cathode active material and the anode active material therefore influences the avoidance of formation losses.

According to the invention, the cathode has a composite cathode active material which is a combination of a fully sodiated first cathode active material and a fully desodiated second cathode active material. This combination makes it possible, in a particularly simple manner, by use of a blend of first cathode active material and second cathode active material, to obtain a composite cathode material having a desired overall sodiation level which is partly desodiated prior to the first discharging and/or charging operation of the sodium ion battery.

In particular, it is possible to dispense with the use of merely partly desodiated cathode active materials, production of which is inconvenient and costly. Moreover, it is also possible in this way to use cathode active materials that are not producible in the partly desodiated state, while an overall sodiation level not equal to 0 and not equal to 1 is still attained.

The term “overall sodiation level” indicates the overall resulting sodiation level of all components of the active material, taking account both of the respective sodiation level of the components and the respective proportion by weight and proportion of the capacitance of the components in the composite cathode active material.

The proportion of the capacitance is dependent on the specific capacitance of the respective cathode active materials, i.e., the specific capacitance of first cathode active material and second cathode active material, and on the proportions by weight of the first cathode active material and the second cathode active material in the composite cathode active material.

For example, in a composite cathode active material consisting of 50% by weight of first cathode active material and 50% by weight of second cathode active material, where the first cathode active material has twice as high a specific capacity than the second cathode active material, the overall sodiation level S is 0.33.

If the first cathode active material and the second cathode active material have the same specific capacity, the overall sodiation level of the composite cathode active material is correspondingly dependent merely on the respective proportion by weight of first cathode active material and second cathode active material in the composite cathode active material.

In that case, for example, in a composite cathode active material consisting of 70% by weight of first cathode active material with a sodiation level a of 1 and 30% by weight of second cathode active material with a sodiation level b of 0, the overall sodiation level S is 0.7.

In other words, the overall sodiation level S in this case is the sum total of the products of proportion by weight and sodiation level of all components of the active material.

Since the sodium ions are also intercalated in the second cathode active material after the filling with electrolyte and especially in the first discharging cycle, the ratio of the sodiation level of the first and second cathode active materials can balance out after the filling with electrolyte and/or after the first discharging and/or charging operation of the sodium ion battery from the original state in the composite cathode active material. Because the formation loss, however, occurs virtually exclusively during the first discharging and/or charging operation, the original state of the composite cathode active material is of particular significance for avoidance of formation losses. Therefore, the figures relating to the sodiation levels of first and second cathode active materials in the composite cathode active material of the invention relate to the state prior to the first discharging and/or charging operation and especially prior to the filling with electrolyte.

According to the invention, the anode active material is pre-sodiated prior to the first discharging and/or charging operation of the sodium ion battery. The term “pre-sodiated” or “presodiation” indicates that the anode active material already includes at least some sodium in the structure of the anode active material prior to the first discharging and/or charging operation of the sodium ion battery, especially in adsorbed or intercalated form.

The sodium used for the presodiation may either be available at a later stage as a sodium reserve in the charging and discharging cycles of the sodium ion battery or may be utilized for formation of an SEI even before or during the first discharging and/or charging operation of the sodium ion battery. The presodiation can thus at least partly compensate for the formation losses that otherwise occur. In this way, it is possible to minimize the amount of costly and possibly toxic cathode active materials or of toxic compounds that possibly occur in the processing of the cathode active materials, and/or to increase the energy density of the cell.

In addition, it is not the case that the reactions for formation of the SEI must take place only in the first discharging and/or charging operation of the assembled sodium ion battery; instead, these can be conducted at least partly even in the course of production of the anode active material and/or anode, especially after introduction of the electrolyte.

The combination of an at least partly desodiated composite cathode active material and an electively sub-stoichiometric pre-sodiated anode active material has the result that the sodium ion battery is already at least partly charged directly after assembly and is thus immediately suitable for use.

The first discharging and/or charging operation may correspondingly be effected directly in the intended application, for example, on the part of the final customer. Individual electrochemical cells may also first be combined to form a battery module and only then discharged and/or charged for the first time.

In this way, it is possible to dispense with the precharging step and the forming step, i.e., the first charging of the sodium ion battery, during the production process, which shortens the production time. Moreover, power consumption in manufacture and the extent and operation of the production plants required are reduced.

In particular, the composite cathode active material prior to the first discharging and/or charging operation of the sodium ion battery has an overall sodiation level of 0.99 or less, preferably of 0.95 or less, more preferably of 0.75 or less, further preferably of 0.5 or less.

The composite cathode active material may also, prior to the first discharging and/or charging operation of the sodium ion battery, have an overall sodiation level of greater than 0, preferably of at least 0.25, more preferably of at least 0.5.

Fully desodiated cathode active materials are commercially available or can be obtained by electrochemical extraction of sodium from fully or partly sodiated cathode active materials.

Chemical extraction of sodium from fully or partly sodiated cathode active materials is also possible, in which the sodium is leached out by means of acids, for example by means of sulfuric acid (H₂SO₄).

A further option is to obtain desodiated cathode active materials by solid-state synthesis or precipitation reactions.

According to the invention, the first cathode active material and/or the second cathode active material is a polyanionic cathode active material.

Polyanionic cathode active materials are known as active materials for sodium ion batteries. By way of general prior art for use of polyanionic cathode active materials in sodium ion batteries, reference is made by way of example to EP 3 933 997 A1 and Hasa et al.: “Challenges of today for Na-based batteries of the future: From materials to cell metrics” (Journal of Power Sources, 2021, 282, 22872, doi: 10.1016/j.jpowsour.2020.228872).

The nature of the polyanionic cathode active material is fundamentally not restricted further.

Polyanionic cathode active materials are fully compatible with standard electrode binders, electrolyte compositions and conductivity additives, for example, conductive carbon black, and with standard production processes of cathode active materials, for example, in mixing, coating, calendering, stamping, cutting, winding, stacking, vacuum, drying and lamination processes, and electrolyte filling.

In particular, it is possible to use polyanionic cathode active materials having a particle size in the range from 0.1 up to 35 μm, preferably from 1 up to 20 μm. Such particle sizes have optimal suitability for blending the cathode active material with further particles, especially with conductive carbon black. This makes it possible to obtain a homogeneous cathode coating composition that can be used as composite cathode in the sodium ion battery after a carrier solvent has dried off and compaction.

More preferably, the composite cathode active material consists of a first cathode active material which is a fully sodiated polyanionic cathode active material, and a second cathode active material which is a fully desodiated polyanionic cathode active material.

The polyanionic cathode active material is especially selected from the group consisting of phosphates, sulfates, silicates and combinations thereof. Corresponding polyphosphates, polysulfonates and polysilicates are included in this selection.

The polyanionic cathode active material is preferably selected from compounds having a NASICON structure, tavorite structure, olivine structure, alluaudite structure, layered compounds and combinations thereof. Such compounds are capable of reversibly accepting and releasing sodium ions, while the fundamental structure of the cathode active material is essentially conserved. This reduces stress on the cathode material during charging and discharging cycles and hence increases the lifetime of the sodium ion battery.

The term “layered compounds” in this context does not include layered oxides that have oxygen anions and can be described by the general formula NaₓMO₂ where M denotes a transition metal.

The polyanionic cathode active material may contain a transition metal selected from the group consisting of iron, manganese, vanadium and combinations thereof.

For example, the polyanionic cathode active material is selected from the group of compounds: Na₁₋ₓFePO₄ (NFP), Na_{2-x′}Fe₃ (PO₄)₃, Na_{2-x′}FeP₂O₇, Na₁₋ₓMnPO₄, Na_{2-x′}MnP₂O₇, Na_{2-x′}MnP₂O₇, Na₂₋ₓMnPO₄F, Na_{4-x′″}(Fe,Mn)₃ (PO₄)₂ (P₂O₇), Na_{3-x″}V₂ (PO₄)₃ (NVP), Na_{3-x″}V₂ (PO₄)₂F₃ (NVPF), Na_{3-x″}V_{2-y} (VO)_{y} (PO₄)₂F_{3-y}, Na_{2-x′}Fe₂ (SO₄)₃, Na_{2+2z-x″}Fe_{2-z} (SO₄)₃, Na_{2-x′}Mn₂ (SO₄)₃, Na_{2-x′}Fe₂ (SiO₄)₃, Na₂₋ₓMn₂ (SiO₄)₃, Na_{2-x′}FeSiO₄, Na_{2-x′}MnSiO₄ and combinations thereof, where 0≤y<3 and 0≤z<2, and where, in the case of a fully desodiated cathode active material, x=1, x′=2, x″=3 and x′″=4, and in the case of a fully sodiated cathode active material, x, x′, x″ and x′″=0.

It is also possible that the polyanionic cathode active material has been doped, where the element used for the doping partly replaces the respective transition metal present in the active material. For example, a polyanionic cathode active material including a transition metal selected from the group consisting of iron, manganese, vanadium and combinations thereof may have been doped with an element selected from the group consisting of manganese, chromium, nickel, cobalt, copper and combinations thereof.

Doping means a content of the respective element in a proportion of not more than 5 percent by weight, based on the total weight of the polyanionic cathode active material, especially in a proportion of not more than 1 percent by weight.

In one embodiment, the first cathode active material is a polyanionic cathode active material, and the second cathode active material is selected from the group consisting of layered sodium oxides, sodium spinels and Prussian Blue analog (PBA).

In a further embodiment, the first cathode active material is selected from the group consisting of layered sodium oxides, sodium spinels and Prussian Blue analog (PBA), and the second cathode active material is a polyanionic cathode active material.

Prussian Blue analog is especially selected from the group consisting of compounds NaₓM[M′(CN)₆]_{1-y}*z H₂O, where 0≤y<1 and z≥0, and where M and M′ are each selected from the group consisting of the transition metals, preferably from the group consisting of iron, manganese, chromium, nickel, cobalt and copper. If the Prussian Blue analog is fully sodiated, x is in particular 2. If the Prussian Blue analog is fully desodiated, x is in particular 0.

M and M′ are preferably each selected from the group consisting of iron, manganese and chromium. Accordingly, the Prussian Blue analog is preferably free of nickel and cobalt.

More preferably, the combination of M and M′ (M/M′) is selected from the group consisting of Fe and Fe (Fe/Fe), Fe and Mn (Fe/Mn), and manganese and manganese (Mn/Mn).

In principle, the ratio of the proportions by weight of first cathode active material and second cathode active material in the composite cathode active material may be chosen as desired.

The second cathode active material is preferably present in a proportion of 1% to 50% by weight, based on the total weight of the first cathode active material and the second cathode active material, preferably in a proportion of 5% to 30% by weight.

As well as the cathode active material, the cathode may also comprise additions such as binders and electrical conductivity additives.

The binder (also referred to as electrode binder) is especially selected from the group consisting of polyethylene oxide (PEO), polytetrafluoroethylene (PTFE), polyvinylidene fluoride (PVdF), polyvinylidene fluoride-hexafluoropropylene copolymer (PVdF-HFP), cellulose, acrylates (for example polymethylmethacrylate), polyvinylpyrrolidone (PVP), styrene-butadiene rubber (SBR), polyisobutene (PIB), polyethylene (PE), polypropylene (PP) and mixtures thereof.

The electrical conductivity additive may be selected from the group consisting of conductive carbon black, carbon nanotubes (CNT), graphene, graphite, expanded graphite and carbon nanofibers, porous carbons (as described, for example, in EP 2 528 879 B1 and DE 10 2013 106 114 A1), gas phase-produced carbon nanofibers (also referred to as VGCF: vapor grown carbon fibers) and combinations thereof.

The anode active material may be selected from the group consisting of hard carbon, soft carbon, synthetic graphite, natural graphite, graphene, mesocarbon, doped carbon, tin, tin oxide, phosphorus, antimony, antimony oxide, Prussian Blue analog and mixtures thereof.

Prussian blue analog in the anode active material may be selected analogously to the Prussian blue analogs described for the composite cathode active material, except that 0≤x<2.

More preferably, the anode active material is hard carbon.

In particular, the hard carbon may be a hard carbon that has been produced industrially from renewable materials by corresponding carbonization. Corresponding hard carbon products are sold, for example, by Stora Enso under the Lignode® name.

The anode active material has especially been pre-sodiated to such an extent that, prior to the first discharging and/or charging operation of the sodium ion battery, there is more sodium than required to form the SEI during anode production and/or the formation of the sodium ion battery.

The anode active material, prior to the first discharging and/or charging operation of the sodium ion battery, preferably has a sodiation level of greater than 0 and additionally a stable SEI.

The anode active material has especially been sub-stoichiometrically pre-sodiated prior to the first discharging and/or charging operation. In other words, the sodiation level of the anode active material is in particular less than 1.

In particular, the sodiation level of the anode active material prior to the first discharging and/or charging operation may be in the range from 0.01 to 1, preferably in the range from 0.05 to 0.6, more preferably from 0.1 to 0.5.

If the anode active material already contains sodium that cannot take part in cycling because it cannot be extracted electrochemically, i.e. is not active sodium, this proportion of sodium, in accordance with the invention, is not regarded as part of the presodiation.

In addition to the anode active material, the anode may include further components and/or additions, for example a carrier, a binder and/or an electrical conductivity additive. Further components and additions used may be all the customary compounds and materials known in the art, and the compounds already described for the cathode.

The anode active material, prior to the first discharging and/or charging operation of the sodium ion battery, has preferably been pre-sodiated to such an extent that the sodium ion battery prior to the first discharging and/or charging operation has a state of charge (“SoC”) in the range from 1% to 100%, preferably from 5% to 60%, more preferably from 10% to 50%.

The SoC indicates the capacitance of the sodium ion battery still available in relation to the maximum capacitance of the sodium ion battery, and can be determined in a simple manner, for example, via the voltage and/or current flow of the sodium ion battery.

The amount of sodium that has to be used for the presodiation of the anode active material in order to achieve a particular SoC prior to the first discharging and/or charging operation of the sodium ion battery is dependent on whether an SEI has already been formed on the anode active material prior to the first discharging and/or charging operation of the sodium ion battery. If no SEI has been formed yet on the anode active material, the anode active material should have been so significantly pre-sodiated that the sodium added is sufficient both for the formation of the SEI and for attainment of the corresponding capacitance of the sodium ion battery. The amount of sodium required for the formation of the SEI can be estimated from the anode active materials used.

The SoC of the sodium ion battery prior to the first discharging and/or charging operation is adjustable not only via the presodiation of the anode active material but also via the overall sodiation level of the composite cathode active material.

The overall sodiation level of the composite cathode active material may be matched to the presodiation of the anode active material. In other words, the overall sodiation level of the composite cathode active material can be lowered by the amount of sodium which is utilized for the presodiation of the anode active material. In this way, the energy density or open cell voltage of the sodium ion battery is optimized further.

It is also possible for the anode active material to have been pre-sodiated to such an extent as to result in a sodium surplus in the sodium ion battery, but at the same time with an SoC prior to the first discharging and/or charging operation of the sodium ion battery within the aforementioned ranges. A sodium surplus may serve to improve the lifetime of the sodium ion battery.

Between the cathode and the anode, the sodium ion battery of the invention has a separator that separates the two electrodes from one another, i.e. the cathode and the anode.

The separator is permeable to sodium ions but is a nonconductor for electrons.

Separators used may be polymers, especially a polymer selected from the group consisting of polyesters, especially polyethylene terephthalate, polyolefins, especially polyethylene and/or polypropylene, polyacrylonitriles, polyvinylidene fluoride, polyvinylidene-hexafluoropropylene, polyetherimide, polyimide, aramid, polyether, polyetherketone, synthetic spider silk (as described, for example, in DE 10 2018 205 484 A1) and mixtures thereof. The separator may optionally additionally have been coated with ceramic material, for example, with SiO₂ or Al₂O₃.

In addition, the sodium ion battery has an electrolyte which is conductive for sodium ions and which may be either a solid-state electrolyte or a liquid comprising an electrolyte solvent and at least one conductive sodium salt dissolved therein, for example, sodium hexafluorophosphate (NaPF₆). Further possible conductive sodium salts may be: sodium triflate (NaCF₃SO₃), sodium tetraborate (NaBF₄), sodium bis(trifluoromethylsulfonyl)-amide (NaTFSI), sodium bis(trifluoromethylsulfonyl)amide (NaFSI), sodium bis(oxalato) borate (NaBOB).

The electrolyte solvent is preferably inert. Suitable electrolyte solvents are, for example, organic solvents such as ethylene carbonate (EC), propylene carbonate (PC), butylene carbonate (BC), dimethyl carbonate (DMC), diethyl carbonate (DEC), ethyl methyl carbonate (EMC), fluoroethylene carbonate (FEC), vinylene carbonate (VC), sulfolane, 2-methyltetrahydrofuran, acetonitrile and 1,3-dioxolan.

In one embodiment, two or more of the abovementioned liquids may be used.

Preferred conductive sodium salts are sodium salts that have inert anions and are preferably nontoxic. Suitable sodium salts are especially sodium hexafluorophosphate (NaPF₆), sodium tetrafluoroborate (NaBF₄) and mixtures of these salts.

If the electrolyte is liquid, the separator has in particular been soaked or wetted with the electrolyte.

The object of the invention is also achieved by a process for producing a sodium ion battery, comprising the following steps: a composite cathode active material is provided by mixing a first cathode active material and a second cathode active material, where the first cathode active material and/or the second cathode active material is a polyanionic cathode active material, and where the first cathode active material is fully sodiated and the second cathode active material is fully desodiated. An anode active material is provided. The composite cathode active material is installed in a cathode and the anode active material in an anode, and the cathode and the anode are assembled to form a sodium ion battery. The anode active material is pre-sodiated before or after the installation of the anode active material in the anode.

The individual constituents of the sodium ion battery produced in the process of the invention have especially been manufactured from the materials described above for the sodium ion battery of the invention.

Accordingly, the above-described sodium ion battery of the invention is especially obtainable by the process of the invention.

The composite cathode active material is obtained in accordance with the invention by mixing the first and second cathode active materials. In other words, the composite cathode active material is especially a blend of first cathode active material and second cathode active material. It is thus particularly simple to obtain a composite cathode active material having a desired overall sodiation level.

The anode active material can especially be pre-sodiated by the techniques known in the art for the production of sodium-containing active materials.

For example, it is possible to produce a mixture of the anode active material with metallic sodium. The mixture of anode active material may be stored for a period of up to two weeks, preferably of up to one week, more preferably of up to five days. In this period, the sodium may be intercalated into the anode active material, so as to obtain a pre-sodiated anode active material.

In one embodiment, the anode active material can be pre-sodiated by blending the anode active material with a sodium precursor and then converting the sodium precursor to metallic sodium.

In a further embodiment, the anode active material can be pre-sodiated by injecting sodium into the anode active material and/or the anode.

In a further embodiment, the anode active material can be pre-sodiated by vapor deposition of sodium onto the anode active material and/or the anode.

By storing the anode in an electrolyte over a particular period of time of, for example, 2 minutes to 14 days, it is possible to form a stable SEI on the anode.

Finally, it is possible to conduct the presodiation of the anode active material by electrochemical treatment of the anode active material that has been installed to form an anode in a sodium-containing electrolyte. In this way, the SEI can be formed on the anode even during the presodiation. Storing the anode in the electrolyte can further complete and kinetically stabilize the SEI.

In order to produce a directly usable sodium ion battery, the sodium ion battery, immediately after the assembly step, prior to a first discharging and/or charging operation of the sodium ion battery, may have a state of charge (SoC) in the region of >1%.

The object of the invention is also achieved by the use of a sodium ion battery as described above in a vehicle, a stationary energy storage means or a portable device. The portable device may especially be a smartphone, a power tool, a tablet or a wearable. The sodium ion battery is preferably used in a vehicle, for example, a hybrid or electric vehicle.

Further benefits and properties of the invention will be apparent from the description that follows, and the examples, which should not be interpreted in a limiting manner.

Table 1 lists the substances and materials used in the examples.

TABLE 1
Substances and materials used.

| | Description |
|---|---|
| NaFePO₄ | Fully sodiated cathode active material |
| FePO₄ | Fully desodiated cathode active material |
| PVdF | Polyvinylidene fluoride, binder |
| NMP (electronic grade) | N-methyl-2-pyrrolidone |
| | Carrier solvent for cathode |
| Aluminum carrier foil (for example rolled | Carrier foil for cathode and anode |
| foil) | |
| Hard carbon | Anode active material |
| SBR | Styrene-butadiene rubber, binder |
| CMC | Carboxymethylcellulose, binder |
| Super C65 (conductive carbon black) | Electrical conductivity additive |
| Sodium | Sodiating agent |
| Polyolefin separator | Separator (25 μm) |
| Liquid electrolyte, comprising a solution | Liquid electrolyte with conductive sodium |
| of 1M NaPF₆ in organic carbonates (e.g. | salt |
| ethylene carbonate (EC), diethylene | |
| carbonate (DEC)) | |
| Aluminum composite foil | Packaging foil for the pouch cell |

### EXAMPLE 1 (REFERENCE EXAMPLE)

A blend of 94% by weight of sodium iron phosphate (NaFePO₄, NFP), 3% by weight of PVdF, and 3% by weight of conductive carbon black is suspended in NMP at 20° C. with a dissolver mixer at high shear. This affords a homogeneous cathode coating composition which is knife-coated onto a 15 μm-thick rolled aluminum carrier foil. Extraction of the NMP affords a composite cathode film having a basis weight of 19.5 mg/cm².

Analogously, an anode coating composition is produced with a composition of 94% by weight of hard carbon, 2% by weight of SBR, 2% by weight of CMC and 2% by weight of Super C65 and applied to a 15 μm-thick rolled aluminum carrier foil. The anode film thus produced has a basis weight of 5.7 mg/cm².

The cathode with the cathode film is assembled using an anode with the anode film, a separator (thickness: 25 μm) of polypropylene (PP) and a liquid electrolyte of a 1M NaPF₆ solution in EC/DMC (3:7 w/w) to form an electrochemical cell with active electrode area 25 cm², which is packed in high-grade aluminum composite foil (thickness: 0.12 mm) and sealed. The result is a pouch cell having outside dimensions of about 0.5 mm×6.4 mm×4.3 mm.

The cell is charged for the first time up to 3.5 V (C/10) and then discharged at C/10 to 2.0 V.

The capacitance of the first charge is 52.5 mAh and the capacitance of the first discharge is 38.5 mAh. This results in a formation efficiency of about 73.3% for the complete cell, i.e. in a formation loss of about 26.7%.

### EXAMPLE 2 (SODIUM ION BATTERY OF THE INVENTION)

A blend of 65.8% by weight of sodium iron phosphate (NaFePO₄), 28.2% by weight of FePO₄, 3% by weight of PVdF, and 3% by weight of conductive carbon black is suspended in NMP at 20° C. with a mixing apparatus at high shear. This affords a homogeneous cathode coating composition which is knife-coated onto a 15 μm-thick rolled aluminum collector carrier foil. Extraction of the NMP affords a composite cathode film having a basis weight of 19.5 mg/cm².

Analogously, an anode coating composition is produced with a composition of 94% by weight of hard carbon, 2% by weight of SBR, 2% by weight of CMC and 2% by weight of Super C65 and applied to a 15 μm-thick rolled aluminum collector carrier foil. The anode film thus produced has a basis weight of 7.5 mg/cm².

Prior to cell assembly, this anode film is pre-sodiated with 30.8 mAh of sodium. About 15.7 mAh of sodium therefrom forms an SEI protective layer, and about 15.1 mAh of sodium remains in the hard carbon as cyclable sodium.

30.8 mAh of sodium corresponds to about 1.15 mmol or about 26.5 mg of sodium.

The cathode with the cathode film is assembled using an anode with the anode film, a separator (25 μm) and an electrolyte of a 1 M solution of NaPF₆ in EC/DMC (3:7 w/w) to form an electrochemical cell with electrode area 25 cm², which is packaged and sealed in aluminum composite foil (thickness: 0.12 mm). The result is a pouch cell with outside dimensions of about 0.5 mm×6.4 mm×4.3 mm.

After dosage of the electrolyte and final sealing of the cell of the invention, it has an open voltage of about 2.3 to 2.9 V, which results from the potential difference of the partly desodiated cathode and the pre-sodiated anode. The nominal capacitance of the sodium ion battery is 50.4 mAh, and so the sodium ion battery directly after production has a state of charge (SoC) of 30%.

The cell is charged for the first time to 3.5 V (C/10) and then discharged at C/10 to 2.0 V. Since the cell, after the assembly and activation with liquid electrolyte, already has an SoC of 30%, a charge of 35.3 mAh is observed on further forming at C/10, while the first C/10 discharge is 50.4 mAh.

The sodium ion battery of the invention accordingly has 31% higher nominal capacitance with identical overall cathode loading and a 32% increase in anode loading compared to the reference example.

In a further configuration, it would also alternatively be possible to keep the anode loading constant with respect to the reference example and to reduce the cathode loading, which results in a similar nominal capacitance, but with distinctly reduced cathode material use.

Since the sodium ion battery is produced using an anode with pre-sodiated anode active material and partly desodiated composite cathode active material, the sodium ion battery of the invention can be used directly after the manufacturing step.

1-10. (canceled)

11. A sodium ion battery comprising:
a cathode comprising a composite cathode active material; and
an anode comprising an anode active material,
wherein the composite cathode active material comprises at least a first cathode active material and a second cathode active material, wherein the first cathode active material and/or the second cathode active material is a polyanionic cathode active material,
wherein the first cathode active material is fully sodiated and the second cathode active material is fully desodiated prior to a first discharging and/or charging of the sodium ion battery, and
wherein the anode active material is pre-sodiated prior to the first discharging and/or charging of the sodium ion battery.

12. The sodium ion battery according to claim 11, wherein the polyanionic cathode active material is selected from the group consisting of phosphates, sulfates, silicates and combinations thereof.

13. The sodium ion battery according to claim 12, wherein the polyanionic cathode material is selected from compounds having a NASICON structure, a tavorite structure, an olivine structure, an alluaudite structure, layered compounds or combinations thereof.

14. The sodium ion battery according to claim 12, wherein the polyanionic cathode material contains a transition metal selected from the group consisting of iron, manganese, vanadium and combinations thereof.

15. The sodium ion battery according to claim 11, wherein the second cathode active material is present in a proportion of 1% to 50% by weight, based on the total weight of the first cathode active material and the second cathode active material,

16. The sodium ion battery according to claim 15, wherein the second cathode active material is present in a proportion of 5% to 30% by weight, based on the total weight of the first cathode active material and the second cathode active material.

17. The sodium ion battery according to claim 11, wherein the anode active material is selected from the group consisting of hard carbon, soft carbon, synthetic graphite, natural graphite, graphene, mesocarbon, doped carbon, tin, tin oxide, phosphorus, antimony, antimony oxide, Prussian Blue analog and mixtures thereof.

18. The sodium ion battery according to claim 11, wherein the anode active material, prior to the first discharging and/or charging of the sodium ion battery, has been pre-sodiated to such an extent that the sodium ion battery prior to the first discharging and/or charging has a state of charge (SoC) in the range from 1% to 100%.

19. The sodium ion battery according to claim 18, wherein the anode active material, prior to the first discharging and/or charging of the sodium ion battery, has been pre-sodiated to such an extent that the sodium ion battery prior to the first discharging and/or charging has a state of charge (SoC) in the range from 5% to 60%.

20. The sodium ion battery according to claim 19, wherein the anode active material, prior to the first discharging and/or charging of the sodium ion battery, has been pre-sodiated to such an extent that the sodium ion battery prior to the first discharging and/or charging has a state of charge (SoC) in the range from 10% to 50%.

21. A process for producing a sodium ion battery, comprising the following steps:
providing a composite cathode active material by mixing a first cathode active material and a second cathode active material, wherein the first cathode active material and/or the second cathode active material is a polyanionic cathode active material, wherein the first cathode active material is fully sodiated and the second cathode active material is fully desodiated;
providing an anode active material;
installing the composite cathode active material in a cathode and the anode active material in an anode; and
assembling the cathode and the anode to form a sodium ion battery;
wherein the anode active material is pre-sodiated before or after the anode active material is installed in the anode.

22. The process according to claim 21, wherein the sodium ion battery immediately after the assembly step, prior to a first discharging and/or charging of the sodium ion battery, has a state of charge (SoC) of >1%.

23. A vehicle comprising the sodium ion battery according to claim 11.

24. A stationary energy storage means or a portable device comprising the sodium ion battery according to claim 11.
